(19) United States
(12) Patent Application Publication
(10) Pub. No.: US 2010/0247906 A1
(43) Pub. Date: Sep. 30, 2010

(54) HEAT-RESISTANT ADHESIVE SHEET

(75) Inventors: Jun-Ho Lee, Gyeonggi-do (KR); Hae-Sang Jeun, Seoul (KR); Ki-Jeong Moon, Seoul (KR); Chang-Hoon Sim, Seoul (KR)

Correspondence Address: HARNESS, DICKEY, & PIERCE, P.L.C, 7700 Bonhomme, Suite 400, ST. LOUIS, MO, 63105, US

(73) Assignee: TORAY SAEHAN INC., Gyeongsangbuk-do (KR)

(21) Appl. No.: 12/159,839

(22) PCT Filed: Aug. 22, 2007
(86) PCT No.: PCT/KR07/04007

§ 371 Date: Jul. 1, 2008

(30) Foreign Application Priority Data
Aug. 3, 2007 (KR) 10-2007-0078073

(51) Int. Cl. C09J 7/02; B32B 15/08; B32B 7/12

(52) U.S. Cl. 428/344; 428/345

(57) ABSTRACT

The present invention relates to a heat-resistant adhesive sheet (tape). More particularly, the invention relates to a heat-resistant adhesive sheet of high reliability and workability, in which crosslink reaction can be induced through irradiation of energy rays on an adhesive layer to achieve heat resistance at high temperature and also high dimension stability in parts, to achieve release without leaving any adhesive residues on an attached surface in releasing the layer and also to achieve no oxidation on the attached surface, e.g., a metallic surface at a high temperature. To this end, the heat-resistant adhesive sheet (tape) according to the invention is characterized by comprising a heat-resistant substrate, and an adhesive layer formed on at least one side of the heat-resistant substrate and made with a coating of liquid comprising energy ray curable olygomer resin, thermosetting adhesive resin, energy ray initiator and thermosetting agent, the adhesive layer being cured and heat resistant by irradiating energy rays to induce crosslink reaction.

### TECHNICAL FIELD

The present invention relates to a heat-resistant adhesive sheet (tape). More particularly, the invention relates to a heat-resistant adhesive sheet of high reliability and workability, in which crosslink reaction can be induced through irradiation of energy rays on an adhesive layer to achieve heat resistance at high temperature and also high dimension stability in parts, to achieve releasing the adhesive layer without leaving adhesive residue on an attached surface and also to achieve no oxidation on the attached surface, e.g., a metallic surface at a high temperature.

Furthermore, the sheet according to the invention can be widely used as an adhesive sheet applicable for a mask sheet in a high temperature process for a variety of electronic parts, and the semiconductor packaging process will be exemplified in the following description but it is noted that the invention should not be limited thereto.

### BACKGROUND ART

In general, the QFN (Quad Flat No Lead package) semiconductor is made by a method of producing semiconductors in which a lead terminal is equipped in a package. There is known a method of producing QFN semiconductors described in the following. First, QFN semiconductors are produced by the steps of attaching a mask sheet of adhesive tape or sheet on one surface of a plurality of lead frames in the adhesive sheet attaching process, and mounting semiconductor chips on a semiconductor element mounting part on the opposite side of the lead frames in the die-attach process. In the wire boding process, electric connection is then carried out by bonding a plurality of leads and semiconductor elements with wire. In the epoxy molding process, the lead frames and the semiconductor elements mounted on the frames are sealed with epoxy resin. Lastly, the mask sheet is released from the lead frames to form a plurality of QFN units and to produce respective unit semiconductors through dicing each unit QFN semiconductor.

As described above, the QFN package producing process should meet very strict requirements of some characteristics in the high temperature process as described below. That is, the process is subject to high temperature between 150° C. and 250° C. In this case, the adhesive sheet must hold the lead frames for more than two hours in the die attach process at 150° C. after being attached to the lead frames. In the wire bonding process at 200 to 250° C., it must keep a high dimension stability for more than two hours and poor bonding between the sheet and the lead frames is not allowed, such as mold flash by means of mold pressure in the epoxy mold process. Lastly, in releasing the adhesive sheet, it must be released without leaving any adhesive residue on the lead frames.

In order to meet the above mentioned requirements, for the conventional adhesive sheet and tape, a heat-resistant polyimide film is usually used as a substrate, on which a heat-resistant adhesive rein layer is deposited. A representative adhesive resin is of silicone and acryl adhesive resin. As disclosed in the registered Korea patent Nos. 10-0665441 and 10-0572191, and U.S. Pat. No. 6,777,079, the above mentioned adhesive resin is used to meet the requirements in a semiconductor producing process.

Also, for the sheet or tape for producing a semiconductor device, glue in addition to adhesive is sometimes used. Such adhesive is produced by mixing thermosetting resin and thermoplastic resin, an example of which is NBR/epoxy resin group, as disclosed in the published Korea patent No. 2004-00423658.

However, the silicone adhesive causes contamination on the attached surface or leaves sticky silicone residues in releasing the sheet. The gas generated from adhesive silicone components at high temperature disadvantageously oxidizes the attached surface of the lead frames.

The thermosetting acryl adhesive is not heat resistant enough, and starts decomposition from the temperature between 100° C. and 150° C., so that adhesive residues are left on the attached surface due to reduced internal cohesion.

The adhesive resin made by mixing thermosetting and thermoplastic resins may result in poor wire bonding by means of volatile gas components during a heating process, and has problems in release capability due to setting shrinkage and increased close adhesion.

### DISCLOSURE

### Technical Problem

The invention was conceived to address the aforementioned problems. It is an object of the present invention to provide a heat-resistant adhesive sheet at high temperature by inducing crosslink reaction through irradiation of energy rays on an adhesive layer for heat resistance.

It is another object of the invention to provide a heat-resistant adhesive sheet of high reliability and workability, in which a high dimension stability in parts can be achieved and there is no adhesive residues on an attached surface in releasing the sheet, and oxidization does not occur on the attached surface, e.g., a metallic surface subject to high temperature.

### Advantageous Effects

The heat-resistant adhesive sheet according to the invention has an effect that crosslink reaction can be induced by irradiating energy rays on the adhesive layer to achieve heat resistance at high temperature.

The heat-resistant adhesive sheet according to the invention has properties of high reliability and workability in that it achieves high dimension stability of parts, can also be peeled without adhesive residues on the attached surface of a substrate, and the surface of the substrate, e.g., metal, on which the adhesive layer according to the invention is deposited, is not oxidized.

### DESCRIPTION OF DRAWINGS

The aforementioned and other advantages and features of the invention will be more apparent from the following description which will exemplify preferred embodiments of the invention and will be elucidated with reference to the accompanying drawing.

FIG. 1 is a cross section of a heat-resistant adhesive sheet according to one embodiment of the invention.

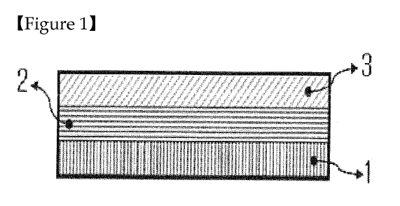

(Simple explanation about marks for the main portion of the drawing)
1: Heat-resistant substrate film
2: Heat-resistant adhesive layer
3: Adhesive layer protection release film

### BEST MODE

The invention is characterized in that the heat-resistant adhesive sheet according to the invention to achieve the aforementioned object comprises a heat-resistant substrate, and an adhesive layer formed on at least one side of the heat-resistant substrate and made with a coating of liquid comprising energy ray curable olygomer resin, thermosetting adhesive resin, energy ray initiator and thermosetting agent, the adhesive layer being cured and heat resistant by irradiating energy rays to induce crosslink reaction.

Preferably, the invention is characterized in that the heat-resistant substrate is foil made of at least one selected among polyester, polyimide, polyamide, polyether sulfone, polyphenylene sulfide, polyether ketone, polyether etherketone, triacetyl cellulose, polyether imide, polyethylene naphthalate, polypropylene and polycarbonate.

Preferably, the invention is characterized in that the heat-resistant substrate is thin metallic foil of at least one selected among thin foil, alloy foil and plated foil, made of aluminum, magnesium, titanium, chrome, manganese, iron, nickel, zinc, tin, etc.

Preferably, the invention is characterized in that one or two or more types of energy ray curable olygomer resin is/are used in the adhesive layer as required for the purpose of design, and the ratio of the energy ray curable olygomer resin to thermosetting adhesive resin in the adhesive layer is 1/9 to 1.

Preferably, the invention is characterized in that the weight average molecular weight of the thermosetting adhesive resin lies between 40,000 and 3,000,000.

Preferably, the invention is characterized in that one or two or more types of energy ray initiator is/are used as required for the purpose of design, and the amount of the energy ray initiator lies between 1/100 and ⅕ as compared to the total amount of the energy ray curable olygomer resin.

Preferably, the invention is characterized in that the energy ray curable olygomer resin in the adhesive layer is cured with visible rays, ultraviolet rays or electron beams.

Preferably, the invention is characterized in that the heat-resistant adhesive sheet is deposited on copper foil and then heated for about 40 minutes at 200° C., the resultant sheet having adhesiveness of 5 g·f/2.54 cm in width to 600 g f/2.54 cm or less in width, after placing it at a room temperature for one hour.

Preferably, the invention is characterized in that the heat-resistant adhesive sheet is deposited on a piece of copper foil, a glass plate or stainless plate and then has adhesiveness of 5 g·f/2.54 cm in width to 120 g·f/2.54 cm or less in width after placing it at a room temperature for one hour.

Preferably, the invention is characterized in that the adhesive weight in the adhesive layer of the heat-resistant adhesive sheet is reduced to 2% or less thereof when it is heated by raising temperature from a room temperature to 250° C., by 10° C./min.

More preferably, the invention is characterized in that the heat-resistant adhesive sheet is deposited on a metallic surface for masking the surface to protect the metallic surface by preventing oxidization on the metallic surface at a high temperature of 250° C.

Hereinafter, preferred embodiments of the invention will be described in detail with reference to the accompanying drawing.

It will be apparent to those skilled in the art that those embodiments are intended to illustrate the invention more specifically, but the scope of the invention should not be limited to those embodiments.

The heat-resistant adhesive sheet according to the invention may be used as a mask sheet in a process of producing various electronic parts, and is not limited to an adhesive sheet for producing semiconductors.

The invention relates to a heat-resistant adhesive sheet, characterized by comprising a heat-resistant substrate and, on one side of the substrate, an adhesive layer made with a coating of liquid comprising energy ray curable olygomer resin, thermosetting adhesive resin, energy ray initiator and thermosetting agent, wherein, in the process of producing the adhesive sheet, energy rays are irradiated to induce crosslink reaction in the adhesive layer, and thereby to form a crosslink structure of high heat resistance.

First, when forming the adhesive layer, since general acrylic adhesive resin is excellent in adhesiveness but is not heat-resistant enough, and starts decomposition from the temperature between 100° C. and 150° C., such an adhesive sheet produced with the acrylic adhesive resin cannot be used as a mask sheet used in a high temperature process. Also, the silicone adhesive resin is excellent in heat resistance but it is hard to control its adhesiveness and silicone residue on a substrate may easily cause contamination. Therefore, there is proposed a method of using acrylic adhesive resin in the invention which is irradiated with energy rays to induce crosslink reaction and thereby to form a novel adhesive layer of heat resistance according to the method of the invention.

The aforementioned acrylic adhesive resin can be made in a mixed crosslink structure known as ‘an interpenetrating polymer network’, wherein the mixed crosslink structure is a crosslink structure in which two different types of curable resin are intertwined by interpenetration during independent crosslinking by each different chemical reaction mechanism. Such a crosslink structure can have characteristics of cohesion and heat resistance of resin, and the ‘interpenetrating polymer network’ is actually used in the method of producing epoxy adhesive resin (see ‘Epoxy Adhesive Formulation’, by Edward M. Petrie, pp. 151 to 152). In the invention, in order to form the mixed crosslink structure by the aforementioned interpenetration and to achieve the object of the invention, the energy ray curing method is used, which is a method of producing a heat-resistant sheet, different from prior art technologies. Hereinafter, components of the invention will be described in more detail.

Heat-Resistant Substrate

The heat-resistant substrate for the heat-resistant adhesive sheet according to the invention is, but not limited to, a (plastic) film made of at least one selected among polyester, polyimide, polyamide, polyether sulfone, polyphenylene sulfide, polyether ketone, polyether etherketone, triacetyl cellulose, polyether imide, polyethylene naphthalate, polypropylene and polycarbonate. Also, for the substrate, metallic foil can be used instead of a plastic film, which can be metallic foil of at least one selected among foil, alloy foil and plated foil made of aluminum, magnesium, manganese, titanium, chrome, iron, nickel, zinc, tin, etc.

For the substrate film, since a difference in the coefficient of thermal expansion between lead frames and the substrate film is large if the coefficient of thermal expansion of the substrate film is large, the lead frame attached to the sheet may be bent when it is placed in a room temperature. Such bending causes dimension instability in the molding process, and may cause thereby disadvantageous mold flash resulting from a displaced position. Therefore, for such a heat-resistant substrate complying with the condition, a heat-resistant film is preferred of which the glass transition temperature is not lower than 150° C. At a temperature between 100° C. and 200° C., the coefficient of thermal expansion of the substrate is preferably 5 ppm/° C. to 50 ppm/° C., more preferably 10 ppm/° C. to 25 ppm/° C.

Adhesive Composition

The energy ray curable acrylic olygomer resin used in the heat-resistant adhesive layer of a heat-resistant adhesive sheet according to the invention can be of one selected among urethane acrylate, polyether and polyester acrylate, epoxy acrylate, acrylic acrylate, etc., or in addition to an acryl group, thiol-added resin with an alryl group at the molecular end, photo-cationic polymerized resin, cinnamoyl containing polymer, diazoa amino-novolac resin. Polymer reactive to high energy rays includes epoxidizing polybutadiene, unsaturated polyester, polyglycidylmethacrylate, polyacrylamide and polyvinyl siloxane. In case of using such energy ray curable resin, the aforementioned parent body material is not always necessarily required. The number of the functional groups reacting with the aforementioned resins is preferably 2 to 6. The weight average molecular weight of the acryl olygomer resin is preferably 300 to 8,000 or so. It is possible to design the resins to react with energy ray initiator in order to give internal cohesion in the adhesive layer, so that an adhesive layer of high heat resistance and without leaving residues on an attached surface can be obtained.

The heat curable adhesive resin used in the heat-resistant adhesive layer of an heat-resistant adhesive sheet according to the invention can be of alkyl(metha)acrylate, e.g, methyl(metha)acrylate, ethyl(metha)acrylate, butyl(metha)acrylate, isoamyl(metha)acrylate, n-hexyl(metha) acrylate, 2-ethylhexyl(metha)acrylate, isooctyl(metha) acrylate, isononyl(metha)acrylate, decyl(metha)acrylate and dodecyl(metha)acrylate, and serves to give adhesiveness. Preferably, the weight average molecular weight of the thermosetting acryl adhesive resin lies between 40,000 and 3,000,000, more preferably between 700,000 and 1,200,000. If the weight average molecular weight of the thermosetting acryl adhesive resin is not more than 40,000, essential heat resistance cannot be obtained. If it is more than 3,000,000, the molecular weight is also large, so that curing reaction can be affected. By using the resins with thermosetting agent, it is possible to accomplish cohesion and to inhibit adhesive residues.

The mixed acryl adhesive of the heat-resistant adhesive sheet according to the invention can achieve curing reaction only when the thermosetting agent or energy ray initiator is contained. An example of curing agent is isonate-, epoxy-, aziridine or chelate crosslink agent. The amount of curing agent is not limited to a specific value, but preferably 0.1 to 20 weight portions, more preferably 2 to 7 weight portions, on the basis of 100 weight portions of acryl adhesive resin. Therefore, it is possible to design the acryl adhesive to have proper adhesiveness by using it with thermosetting agent. Also, an exemplary energy ray initiator is one selected among benzyldimethalketal, hydroxycyclohexyl phenyl ketone, hydroxy dimethyl acetophenone, methyl-[4-methyltiophenyl]-2-morphorine propane, 4-benzyl-4′-methyldiphenyle sulfide, isoprophylthioxanthone, 2-chlorothioxanthone, ethyl-4-dimethylaminobenzoate, 2-ethylhexyl-4-dimethylaminobenzoate, benzophenone, 4-methylbenzophenone, methyl-orotho-benzo-benzoate, methylbenzoyl formate, 4-phenylbenzophenone, 2,4,6-trimethylbenzoyl-diphenyl phosphine, 2-hydroxy-1,2-diphenyl ethanone, etc. The energy ray initiator can be selected depending on coating and drying temperature of the adhesive layer and the condition for irradiating energy rays. The amount of the energy ray initiator is preferably 0.01 to 0.2 weight portions on the basis of 100 weight portions of the energy ray curable olygomer resin. It is preferred to use one or two types of energy ray initiator together depending on the purpose of design.

How to Produce an Adhesive Layer

A method of producing a heat-resistant adhesive sheet according to the invention is not limited to a specific method. A general method of producing it is to produce an adhesive composition in solvent, the composition comprising energy ray curable acryl olygomer resin, thermosetting adhesive resin, energy ray initiator and thermosetting agent components for setting the resins. The adhesive composition is produced with a viscosity according to the purpose of design, to form an adhesive layer through steps of coating the composition directly on a heat-resistant substrate and then drying the layer. This is referred to as a casting method. Another method of producing the adhesive layer is referred to as a transcribing method comprising the steps of coating the aforementioned adhesive on a release film, drying the resultant film to form an adhesive layer, laminating the layer on a heat-resistant substrate and then transcribing the resultant film. In this case, the coating thickness of the adhesive layer is preferably between 5 and 25 μm, more preferably between 6 and 10 μam.

For the heat-resistant adhesive layer according to the invention, it is preferred that the ratio of energy ray curable olygomer resin to thermosetting adhesive resin is 1/9 to one (for solids). In this case, if the amount of the energy ray curable olygomer resin is added more than required, it may be impossible to form a crosslink structure by means of interpenetration or the adhesive layer may become harder than required. Also, one or two or more types of energy ray curable olygomer resin can preferably be used together, depending on the purpose of design.

How to Cure the Adhesive Layer with Energy Rays

The inventive method of curing the adhesive layer with energy rays can induce a crosslink structure in the adhesive layer by curing the layer with energy rays such as visible rays, ultraviolet rays or electron beams. The energy rays are not limited to a specific type, but it is preferable to use ultraviolet rays for curing. Curing with ultraviolet rays is a chemical reaction occurring in a very short time period, and it is required to perform complete curing with a given amount of rays within a given short time period. If curing is performed with a smaller amount of rays than a given value, the cured layer may have an uncured area. If more rays than a given value are used, decomposition may occur in the substrate film or adhesive resin. Since ultraviolet rays involve infrared rays, side effect by the heat of infrared rays may occur. Therefore, it is preferred that the amount of rays is 10 to 2000 mJ/cm², more preferably 400 to 1000 mJ/cm², on the basis of area A of ultraviolet rays. Ultraviolet lamps are classified as mercury lamps having a main area of short wavelength (ultraviolet rays B, C) and metal halide lamps having a main area of long wavelength (ultraviolet rays A). Curing can be achieved with combined use of two types of lamps or with each type of lamps. The amount of rays can be controlled by means of a lamp height or irradiation times of ultraviolet rays. In addition, the thermosetting adhesive resin may be thermoset in an aging room or an oven. It is preferred that thermosetting is carried out at 25° C. to 80° C., more preferably 40° C. to 60° C. The aging period is preferably 5 to 7 days.

With the following embodiments, the invention will be described in more detain, but it should be noted that the invention is not limited thereto.

### Embodiment 1

For 100 weight portions of total liquid, there were used 46.28 weight portions of acryl adhesive resin (AT-211, commercially available from Samwon Co.), 1.62 weight portions of isocinate hardener (CAT-45, commercially available from Samwon Co.), 5.55 weight portions of urethane acrylate which is energy ray curable olygomer (EB280, commercially available from Cytec Co.), 0.19 weight portions of 2,4,6-trimethylbenzoyl-diphenyl phosphine (Darocur TPO, commercially available from Ciba Co.), 0.08 weight portions of hydroxy cyclohexyl phenylketone (Irgacure184, commercially available from Ciba Co.) which is ultraviolet initiator, and 46.28 weight portions of ethyl acetate solvent, in order to produce ultraviolet ray curable and thermosetting adhesive. The adhesive produced as described above was then coated on a polyimide film of a heat-resistant substrate (25NPI, commercially available from Kaneka Co., 25 μm) in a thickness of 10 μm and the resultant film was then dried. Subsequently, the adhesive layer was cured through irradiating ultraviolet rays (800 mJ/cm², the amount of irradiated ultraviolet rays) and aging at 50° C., in order to produce an adhesive tape or sheet.

### Embodiment 2

For 100 weight portions of total liquid, there were used 47.1 weight portions of acryl adhesive resin (AT-211, commercially available from Samwon Co.), 1.7 weight portions of isocinate hardener (CAT-45, commercially available from Samwon Co.), 2.8 weight portions of urethane acrylate which is energy ray curable olygomer (EB280, commercially available from Cytec Co.), 0.1 weight portion of 2,4,6-trimethylbenzoyl-diphenyl phosphine (Darocur TPO, commercially available from Ciba Co.), 0.2 weight portions of hydroxy cyclohexyl phenylketone (Irgacure184, commercially available from Ciba Co.) which is ultraviolet initiator, and 48.1 weight portions of ethyl acetate solvent, in order to produce ultraviolet ray curable and thermosetting adhesive. The adhesive produced as described above was then coated on a polyimide film of a heat-resistant substrate (25NPI, commercially available from Kaneka Co., 25 μm) in a thickness of 10 μm and the resultant film was then dried. Subsequently, the adhesive layer was cured by means of irradiating ultraviolet rays (800 mJ/cm², the amount of irradiated ultraviolet rays) and aging at 50° C., in order to produce an adhesive tape or sheet.

### Embodiment 3

For 100 weight portions of total liquid, there were used 46.28 weight portions of acryl adhesive resin (AT-211, commercially available from Samwon Co.), 1.62 weight portions of isocinate hardener (CAT-45, commercially available from Samwon Co.), 1.85 weight portions of urethane acrylate which is energy ray curable olygomer (EB280, commercially available from Cytec Co.), 3.7 weight portions of phenyl novolac acrylate (EB9656, commercially available from Cytec Co.) which is energy ray curable olygomer, 0.19 weight portions of 2,4,6-trimethylbenzoyl-diphenyl phosphine (Darocur TPO, commercially available from Ciba Co.), 0.08 weight portions of hydroxy cyclohexyl phenylketone (Irgacure184, commercially available from Ciba Co.) which is ultraviolet initiator, and 46.28 weight portions of ethyl acetate solvent, in order to produce ultraviolet ray curable and thermosetting adhesive. The adhesive produced as described above was then coated on a polyimide film of a heat-resistant substrate (25NPI, commercially available from Kaneka Co., 25 μm) in a thickness of 10 μm and the resultant film was then dried. Subsequently, the adhesive layer was cured through irradiating ultraviolet rays (800 mJ/cm², the amount of irradiated ultraviolet rays) and aging at 50° C., in order to produce an adhesive tape or sheet.

In the following table 1, the components in liquid for producing the adhesive used in respective embodiments are shown.

TABLE 1

| | | Weight ratio | | |
|---|---|---|---|---|
| Category | | Embodiment 1 | Embodiment 2 | Embodiment 3 |
| Thermosetting | AT211(solids, 40%) | 46.28 | 47.1 | — |
| adhesive resin and | AT311(solids, 40%) | — | — | 46.28 |
| hardener | CAT45(solids, 50%) | 1.62 | 1.7 | 1.62 |
| Ultraviolet ray | EB280(solids, 100%) | 5.55 | 2.8 | 1.85 |
| curable olygomer | EB9656(solids, 100%) | — | — | 3.7 |
| resin and initiator | Darocur TPO | 0.19 | 0.1 | 0.19 |
| | Irgacure 184 | 0.08 | 0.2 | 0.08 |
| | Ethyl acetate | 46.28 | 48.1 | 46.28 |

| | | | |
|---|---|---|---|
| Amount of irradiated ultraviolet rays (mJ/cm²) | about 800 | about 800 | about 800 |

[Experiment and Result]

Experiment 1: Measuring 180° Peeling-I

There were produced an adhesive sheet or tape with a size of 2.54 cm*15 cm (width*length) and a substrate, the substrate being copper foil (3EC-HTE-AT, commercially available from Mitsui Co.), the surface of which was washed with methylethylketone or acetone. Then, the adhesive sheet was deposited on the copper foil by rubbing the stack twice with a rubber roller (approximately 2 kg) to produce a sample. Right after the process, the sample was placed on a plate at 200° C. then to transfer heat for 40 minutes by placing silicone rubber thereon. Finally, the sample was placed in a room temperature for one hour then to measure 180° peeling for the sample at a speed of 300 mm/min.

Experiment 2: Measuring 180° Peeling-II

There were produced an adhesive sheet or tape with a size of 2.54 cm*15 cm (width*length) and substrates, the substrate being copper foil (3EC-HTE-AT, commercially available from Mitsui Co.), a stainless steel plate and a glass plate, the surface of which was washed with methylethylketone or acetone. Then, the adhesive sheet was deposited on the respective samples by rubbing the stack twice with a rubber roller (approximately 2 kg) to produce samples for respective substrates. Right after the process, the samples were placed at a room temperature for one hour. Then 180° peeling was measured for the samples at a speed of 300 mm/min. After depositing the heat-resistant adhesive sheet produced according to above embodiments 1 to 3 on each substrate, peeling complying with the above method of measuring 180° peeling I and II was measured and the results are shown in the following table 2.

TABLE 2

| | Measuring | 180° Peeling strength (g · f/2.54 cm) | | | |
|---|---|---|---|---|---|
| | criteria for | Embod- | Embod- | Embod- | |
| Substrate | peeling | iment 1 | iment 2 | iment 3 | Remarks |
| Glass | II | 41.79 | 93.05 | 86.68 | 25° C. |
| Stainless | II | 44.57 | 102.92 | 78.41 | 25° C. |
| steel | | | | | |
| Copper | II | 74.60 | — | 93.52 | 25° C. |
| Copper | I | 141.95 | 579.74 | 201.50 | 200° C. × 40 min. |

As can be seen from the above table 2, the samples treated at a room temperature exhibited peeling strength of 40 to 110 g·f/2.54 cm for each substrate type. The samples heat-treated at 200° C. for 40 minutes exhibited increased adhesiveness, that is, peeling strength of 140 to 600 g·f/2.54 cm. In the above embodiments 1 and 2, peeling strength was compared, with respect to the amount of energy ray curable olygomer resin. For 100 weight portions of thermosetting adhesive resin, 30 weight portions were used in the embodiment 1, and 20 weight portions in the embodiment 2 (as seen in the above table 1, the thermosetting resin has 40% of solids melt in solvent, and the ultraviolet ray curable resin is of solids only. The weight portions of these resins indicate the ratio for solids). As a result, it is seen that, the more the content of energy ray curable olygomer resin is, the lower peeling strength is.

Experiment 3: Measuring Residues on a Substrate after Peeling

The surface of each sample substrate (copper foil, glass plate and stainless steel plate) of which the peeling strength (complying with the aforementioned Measuring the 180° peeling strength I and II) was measured was visually examined to check presence or absence of adhesive residues coming from the adhesive sheet. After peeling the adhesive sheet, if there is no remaining residue on the surface other than the adhesive residue remaining on the edge of the adhesive tape or sheet, it is decided to be ‘normal’ sample. If there is some aforementioned adhesive residue, it is decided to be an ‘abnormal’ sample.

After measuring peeling strength of the samples in the above embodiments 1 to 3 according to the aforementioned method of measuring 180° peeling strength, the surface of each sample substrate of copper foil, glass plate and stainless steel plate was visually examined to check residues after peeling. The results are shown in the following table 3. In the following table 3, “∘” indicates a ‘normal’ sample in which there is no adhesive residue on the surface of the substrate.

TABLE 3

| | Criteria | | | | |
|---|---|---|---|---|---|
| | for | Presence/Absence of adhesive residue | | | |
| | measuring | (normal: ◯/abnormal: X) | | | |
| | peeling | Embod- | Embod- | Embod- | |
| Substrate | strength | iment 1 | iment 2 | iment 3 | Remarks |
| Glass | II | ◯ | ◯ | ◯ | 25° C. |
| Stainless | II | ◯ | ◯ | ◯ | 25° C. |
| steel | | | | | |
| Copper | II | ◯ | ◯ | ◯ | 25° C. |
| Copper | I | ◯ | ◯ | ◯ | 200° C. × 40 min. |

As can be seen in the above table 3, there was no adhesive residue on the surface of each sample substrate. Therefore, it is decided that the samples produced according to the embodiments were very good in peeling. The samples heat-treated at a high temperature of 200° C. for 40 minutes (for the sample by the method of measuring peeling strength-I) exhibited heat resistance and internal cohesion.

Experiment 4: Measuring Curling at a High Temperature

There was produced a sample of an adhesive sheet or tape with a size of 3.4 cm*5 cm (width*length). The sample was put on a hot plate to check the curling length of the sample when the temperature rises by 10° C. from 150° C. to 250° C., or drops by 10° C. from 250° C. to 150° C. In this case, the length curled in a horizontal or longitudinal direction of the sample was measured. When it was curled in the direction of the adhesive layer, + values were given, but − values when in the direction of the polyimide film of the substrate film.

With the method II of measuring curling at a high temperature, it was observed how much the adhesive tape produced according to the embodiments 1 and 3 was curled at each temperature range on the hot plate. The results are shown in the following tables 4-1 and 4-2.

[Table 4]

TABLE 4-1

| | Temp. (° C.) | | | | | | | | | | | |
|---|---|---|---|---|---|---|---|---|---|---|---|---|
| | 150 | 160 | 170 | 180 | 190 | 200 | 210 | 220 | 230 | 240 | 250 | Remarks |
| Embodiment 1 | 0 | 0 | 0.2 | 0.2 | 0.2 | 0.2 | 0.3 | 0.3 | 0.5 | 0.5 | 0.5 | Changes |
| (mm) | | | | | | | | | | | | as temp. |
| Embodiment 3 | 0 | 0 | 0 | 0 | 0 | 0 | 0 | 0.3 | 0.3 | 0.5 | 0.5 | rises |
| (mm) | | | | | | | | | | | | |

TABLE 4-2

| | Temp. (° C.) | | | | | | | | | | | | |
|---|---|---|---|---|---|---|---|---|---|---|---|---|---|
| | 250 | 240 | 230 | 220 | 210 | 200 | 190 | 180 | 170 | 160 | 150 | 25 | Remarks |
| Embodiment | 0.5 | 0.3 | 0.3 | 0.3 | 0.2 | 0.2 | 0.1 | 0.1 | 0.1 | 0 | 0 | 0 | Changes |
| 1 (mm) | | | | | | | | | | | | | as temp. |
| Embodiment | 0.5 | 0.3 | 0.3 | 0.2 | 0.2 | 0.2 | 0 | 0 | 0 | 0 | 0 | 0 | drops |
| 3 (mm) | | | | | | | | | | | | | |

As can be seen in the above tables 4-1 and 4-2, all the samples have values within 0.5 min in the horizontal and longitudinal directions at 250° C., which means high dimension stability of parts.

Experiment 5: Testing Antioxidization

An adhesive sheet or tape was attached on a general copper lead frame to mask the surface of the lead frame and the lead frame with the attached adhesive tape between 150° C. and 250° C. was heated for 10 minutes at each temperature range. After the process, the adhesive tape was peeled then to visually observe the masked surface to decide oxidization. In particular, we decided oxidization by comparing the masked surface to the non-masked surface.

The adhesive tape produced according to the embodiments 1 and 3 was deposited on copper foil to mask the surface. Oxidization was then visually observed on the surface of the copper foil after 10 minutes at a given high temperature range. The results are shown in the following table 5.

TABLE 5

| | Temp. (° C.) | | | | | |
|---|---|---|---|---|---|---|
| | 170 | 180 | 190 | 210 | 230 | 250 |
| Embodiment 1 | ◯ | ◯ | ◯ | ◯ | ◯ | ◯ |
| Embodiment 3 | ◯ | ◯ | ◯ | ◯ | ◯ | ◯ |

* ◯: oxidized. X: not oxidized.

As seen in the above table 5 for the results of oxidization at each temperature range for the heat-resistant adhesive sheet produced according to the embodiments 1 and 3, it was decided that the surface of the copper foil with the attached adhesive sheet was not oxidized.

Experiment 6: Measuring Weight Reduction at High Temperature

We obtained adhesive from the adhesive tape produced according to the embodiments of the invention, and carried out measurement of weight reduction of the adhesive at a high temperature with a thermogravimetric analyzer (TGA). The temperature condition for measurement was from a room temperature to 300° C., and the temperature rise speed was 10° C./min.

We obtained an adhesive layer from the adhesive tape produced according to the embodiments 1 and 3, and carried out measurement of weight reduction of the adhesive at a temperature range from a room temperature to 300° C. with a thermogravimetric analyzer (TGA). The results for weight reduction rates at each temperature range are shown in the following table 6.

TABLE 6

| | Temp. (° C.) | | | | | |
|---|---|---|---|---|---|---|
| | 150 | 170 | 190 | 210 | 230 | 250 |
| Embodiment | 99.84 | 99.77 | 99.53 | 99.37 | 99.19 | 98.79 |
| 1 (%) | | | | | | |
| Embodiment | 99.67 | 99.55 | 99.38 | 99.22 | 99.03 | 98.77 |
| 3 (%) | | | | | | |

As can be seen in the above table 6, the adhesive obtained from the embodiments of the invention had weight reduction within 1.5% at 250° C., respectively. Therefore, we can see small weight reduction of adhesive at each high temperature range, and adhesive residues were not left in peeling advantageously.

Hereinabove, the invention were described in detail only with reference to some embodiments, but it will be apparent to those skilled in the art that various modifications and changes can be made within the scope of the invention and it is intended that such modifications and changes are covered by the spirit and scope of the invention as claimed in the appended following claims.

Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1. A heat-resistant adhesive sheet, comprising:
a heat-resistant substrate; and
an adhesive layer formed on at least one side of the heat-resistant substrate and made with a coating of liquid, the liquid comprising:
energy ray curable olygomer resin;
thermosetting adhesive resin;
energy ray initiator; and
thermosetting agent, and
the adhesive layer being cured and heat resistant by irradiating energy rays to induce crosslink reaction.

2. The sheet as claimed in claim 1, wherein the heat-resistant substrate is a film made of at least one selected among from the group consisting of polyester, polyimide, polyamide, polyether sulfone, polyphenylene sulfide, polyether ketone, polyether etherketone, triacetyl cellulose, polyether imide, polyethylene naphthalate, polypropylene and polycarbonate.

3. The sheet as claimed in claim 1, wherein the heat-resistant substrate is thin metallic foil of at least one selected from the group consisting of thin foil, alloy foil and plated foil, made of aluminum, magnesium, titanium, chrome, manganese, iron, nickel, zinc, or tin.

4. The sheet as claimed in claim 1, wherein two or more types of the energy ray curable olygomer resin are used together in the adhesive layer as required for the purpose of design, and the ratio of the energy ray curable olygomer resin to thermosetting adhesive resin in the adhesive layer is 1/9 to 1.

5. The sheet as claimed in claim 1, wherein the weight average molecular weight of the thermosetting adhesive resin lies between about 40,000 and about 3,000,000.

6. The sheet as claimed in claim 1, wherein one or two or more types of the energy ray initiator is/are used as required for the purpose of design, and the amount of the energy ray initiator lies between 1/100 and ⅕ as compared to the total amount of the energy ray curable olygomer resin.

7. The sheet as claimed in claim 1, wherein the energy ray curable olygomer resin in the adhesive layer is cured with visible rays, ultraviolet rays or electron beams.

8. The sheet as claimed in claim 1, wherein the heat-resistant adhesive sheet is deposited on the copper foil and then heat-treated for about 40 minutes at about 200° C., the resultant sheet having adhesiveness of 5 g·f/2.54 cm in width to 600 g·f/2.54 cm or less in width, after placing it at a room temperature for one hour.

9. The sheet as claimed in claim 1, wherein the heat-resistant adhesive sheet is deposited on a piece of copper foil, glass plate or stainless steel plate and then has adhesiveness of 5 g·f/2.54 cm in width to 120 g·f/2.54 cm or less in width after placing it at a room temperature for one hour.

10. The sheet as claimed in claim 1, wherein the weight of the adhesive in the adhesive layer in the heat-resistant adhesive sheet is reduced by 2% or less thereof in weight when it is heated by raising temperature from a room temperature to about 250° C., by about 10° C./min.

11. The sheet as claimed in claim 1, wherein the heat-resistant adhesive sheet is deposited on a metallic surface for masking the metallic surface, in order to protect the surface by preventing oxidization at a temperature of about 250° C.
